(19) United States
(12) Patent Application Publication
(10) Pub. No.: US 2024/0286487 A1
(43) Pub. Date: Aug. 29, 2024

(54) DISPLAY SYSTEM

(71) Applicant: Nippon Seiki Co., Ltd., Niigata (JP)

(72) Inventor: Kazuki Horikawa, Niigata (JP)

(21) Appl. No.: 18/584,847

(22) Filed: Feb. 22, 2024

(30) Foreign Application Priority Data
Feb. 24, 2023 (JP) 2023-027230

(51) Int. Cl. B60K 35/60; G06V 40/16

(52) U.S. Cl. CPC B60K 35/60; G06V 40/172; B60K 2360/178; B60K 2360/21

(57) ABSTRACT

To provide a display system in which a display unit which is on the outside of a vehicle can be effectively used. According to an embodiment, when a person is not seated on a driver's seat of a vehicle, warning images regarding the vehicle are displayed on a display unit disposed on an exterior part of the vehicle; the display unit displays an authentication state of the person and a locked/unlocked state of a door of the vehicle; the warning image is also displayed on a meter of the vehicle; the warning image represents an alighting time warning about the vehicle; the warning image is hidden from display when the person is seated on the driver's seat; and the warning image is hidden from display when the door of the vehicle is locked.

### CROSS-REFERENCE TO RELATED APPLICATIONS

The present application claims priority from Japanese Patent Application No. 2023-027230 filed on Feb. 24, 2023, the entire contents of which are hereby incorporated by reference.

### TECHNICAL FIELD

The present disclosure relates to a display system, and more particularly, to a display system which is mounted on a vehicle.

### BACKGROUND ART

As a conventional technique, Patent Document 1 discloses a system which captures an image of a person outside a vehicle by an imaging unit which is mounted on an exterior part of the vehicle, displays, on a display unit at a window portion of the vehicle, that the system is in a state of being able to authenticate a person, captures a motion of the person, and locks or unlocks a door of the vehicle on the basis of a result of recognition of the motion.

### PRIOR ART DOCUMENT

### Patent Document

Patent Document 1: JP 2021-068084 A

### SUMMARY OF INVENTION

### Technical Problem

However, there lies a problem in which a display device is used to only notify the authentication enabled state by display and the display device has not been used effectively.

Hence, the present invention has been conceived in view of the above problem, and an object of the present invention is to provide a display system in which a display unit which is on the outside of a vehicle can be effectively used.

### Solution to Problem

The display system of the present invention is characterized in that the display system displays, when a person is not seated on a driver's seat C1 of a vehicle C, warning images 23b, 23c, and 23e regarding the vehicle C on a display unit 23 which is disposed on an exterior part of the vehicle C.

### BRIEF DESCRIPTION OF DRAWINGS

FIG. 1 is a diagram illustrating a meter device of a display system of the present disclosure.

FIG. 2 is a diagram illustrating the position of an authentication device for a vehicle of the display system of the present disclosure.

FIG. 3 is a diagram illustrating the authentication device of the display system of the present disclosure.

FIG. 4 is a flowchart showing a first embodiment of the display system of the present disclosure.

FIG. 5 is a diagram illustrating the state in which a warning image is displayed on the authentication device according to the above-mentioned embodiment.

FIG. 6 is a diagram illustrating the state in which a warning image is displayed on an authentication device of a third embodiment of the display system of the present disclosure.

FIG. 7 is a flowchart showing a fourth embodiment of the display system of the present disclosure.

FIG. 8 is a diagram illustrating an authentication device for a vehicle and the position of a flap of a charging port according to the above-mentioned embodiment.

FIG. 9 is a diagram illustrating the state in which a warning image is displayed on the authentication device according to the above-mentioned embodiment.

FIG. 10 is a diagram illustrating the state in which a charging image is displayed on the authentication device according to the above-mentioned embodiment.

### DESCRIPTION OF EMBODIMENTS

With reference to the accompanying drawings, an embodiment of a display system of the present disclosure will be described below by taking a display system which is applied to a car as an example. The present disclosure relates to a display system for a vehicle, and can be applied to, for example, a display system for a vehicle which is mounted on a car or a movable body provided with an agricultural machine or a construction machine.

The display system includes a control unit (not illustrated) inside a vehicle C. The control unit is a thin rectangular integrated circuit (IC) chip mounted on a circuit board, and functions as a microcomputer. The control unit includes a central processing unit (CPU), a read-only memory (ROM), a random-access memory (RAM), and the like, and executes predetermined arithmetic processing in accordance with a program written in the ROM, for example.

The control unit is connected to an electronic control unit (ECU) that electronically controls respective components of the vehicle C and to a meter device (an instrumental device) 1 via an in-vehicle local-area network (LAN). The control unit acquires various kinds of vehicle information via the LAN, and mainly drives and controls an authentication device 2 on the basis of the acquired information.

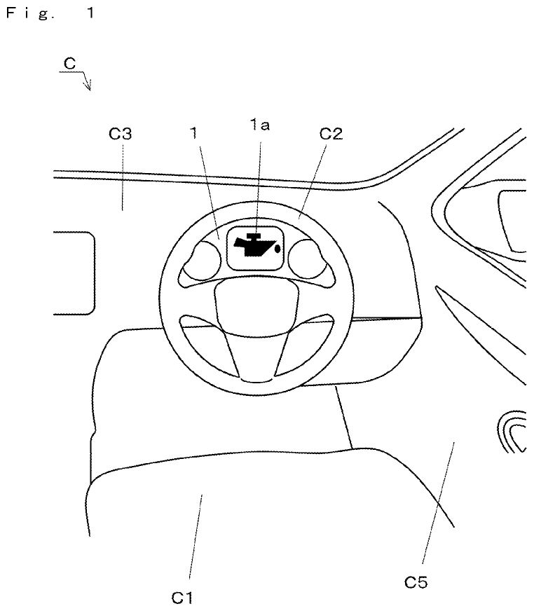

As illustrated in FIG. 1, the meter device 1 is disposed on an instrument panel C3, which is at the back of a steering wheel C2 in front of a driver's seat C1 of the vehicle C. The meter device 1 is a well-known instrumental device including a speedometer, a tachometer, a water temperature gauge, a remaining fuel gauge, an image display unit which displays various kinds of information, various warning lamps, and various actuation lamps.

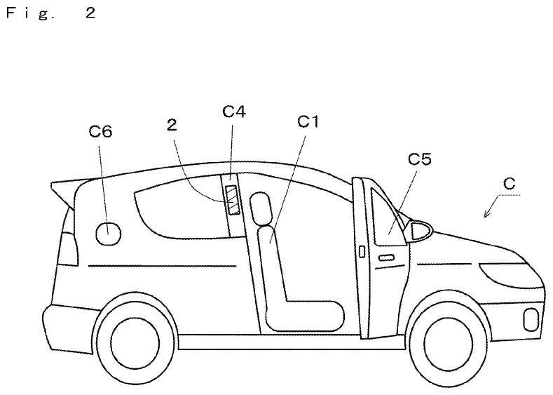

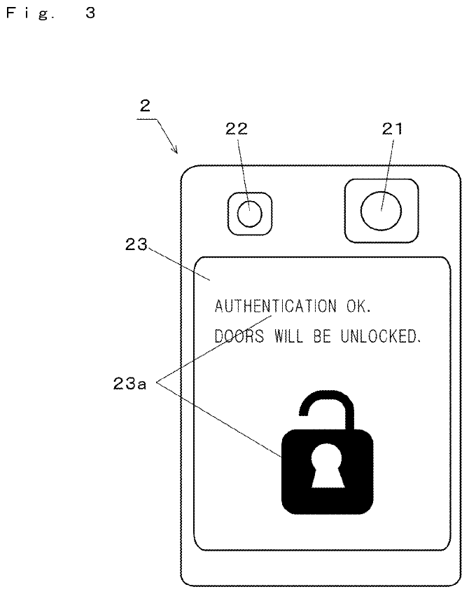

As illustrated in FIG. 2, the authentication device 2 is disposed on the exterior of a B-pillar C4 on both of the left and right sides of the vehicle C such that a person outside the vehicle can visually recognize a display unit 23. As illustrated in FIG. 3, the authentication device 2 includes a human body detection camera 21, an authentication camera 22, and the display unit 23.

When the vehicle C detects a person (a user) approaching the vehicle by means of a non-contact sensor (not illustrated), which is disposed at respective parts of the vehicle C, the control unit activates the human body detection camera 21 of the authentication device 2. The human body detection camera 21 and the authentication camera 22 are configured from a camera which outputs image information generated by image capturing. The human body detection camera 21 is a camera which can capture an image over a wider and farther distance than the authentication camera 22 can, and captures an image over a wide range outside the vehicle C.

When the human body detection camera 21 has detected an approach of a person, the control unit activates the authentication camera 22. The control unit authenticates the person by an image captured by the authentication camera 22. In authenticating the person, the determination is made by checking the features of a face of the person whose image has been captured by the authentication camera 22 against the features of the face of the person registered in the authentication device 2 in advance.

The display unit 23 is, for example, a thin-film transistor (TFT) liquid crystal display panel which is driven by an active matrix driving method, or an organic electro-luminescence (EL) module, whereby various images can be displayed. When the person has not been authenticated by the authentication camera 22, the control unit displays an authentication failure image (not illustrated) indicating “Authentication Failed” on the display unit 23. When the person has been authenticated by the authentication camera 22, the control unit displays, as illustrated in FIG. 3, an authentication OK image 23a indicating “Authentication OK. Doors will be unlocked.”, and also unlocks all of doors C5 of the vehicle C.

The control unit locks the doors C5 when none of the doors C5 is opened even after the elapse of a predetermined time since the doors C5 are unlocked. In this way, the display system uses the authentication device 2 to authenticate a person, and uses the display unit 23 to display the authentication state of the person and also the locked/unlocked state of the doors C5 of the vehicle C.

### First Embodiment

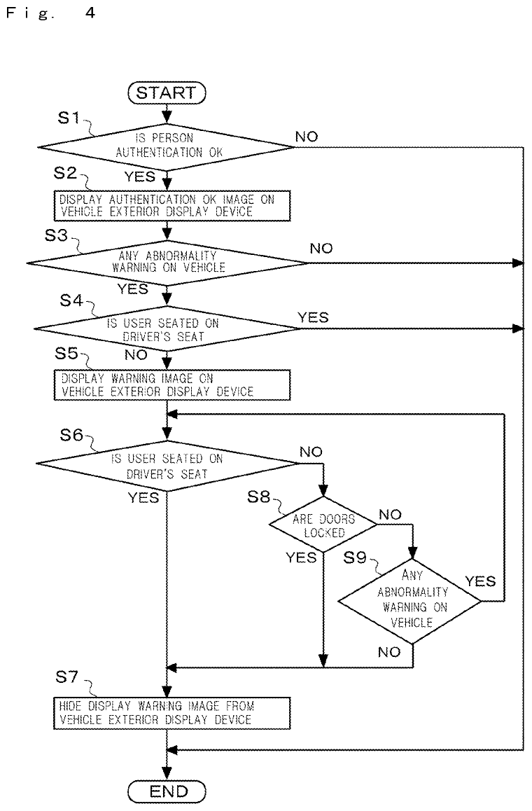

The processing of a first embodiment when the display system controls the authentication device 2, in accordance with a flowchart illustrated in FIG. 4, will be described below.

The control unit determines whether a person is authenticated (step S1). If the person is authenticated (YES in step S1), the control unit displays the authentication OK image 23a on the display unit 23, as illustrated in FIG. 3 (step S2). If it is determined by the control unit that the person is not authenticated (NO in step S1), the control unit ends the processing.

Next, the control unit determines whether or not an abnormality warning is generated on the vehicle C on the basis of information from the ECU (step S3). For example, if it is determined by the control unit that an abnormality warning is generated on the vehicle C, such as that the control unit has obtained information indicating that the pressure of engine oil is reduced from the ECU (YES in step S3), the control unit determines whether the user is seated on the driver's seat C1 (step S4).

The determination of whether the user is seated is made by detection by means of a weight sensor built into the driver's seat C1, or detection by means of a camera which captures an image of the driver's seat C1, and the like. If it is determined by the control unit that no abnormality warning is generated on the vehicle C (NO in step S3), the control unit ends the processing.

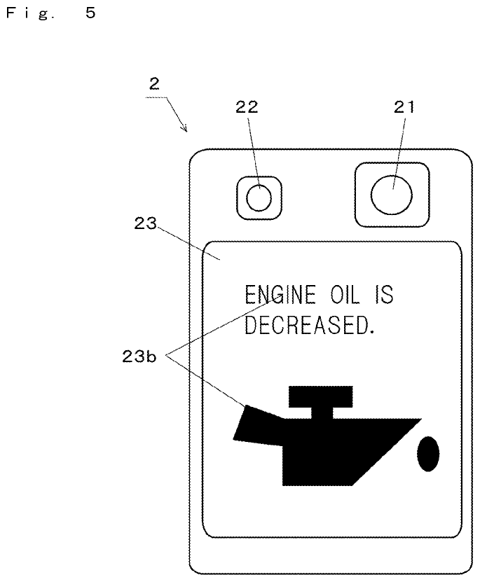

If it is determined by the control unit that the user is not seated (NO in step S4), the control unit displays, as illustrated in FIG. 5, an oil pressure warning image 23b indicating “Engine oil is decreased.” as a warning image on the display unit 23 (step S5). If it is determined by the control unit that the user is seated (YES in step S4), the control unit ends the processing.

Next, the control unit determines again whether the user is seated on the driver's seat C1 (step S6). If it is determined by the control unit that the person is seated (YES in step S6), the control unit hides from display (erases) the oil pressure warning image 23b, which is the warning image on the display unit 23 (step S7). After that, the control unit ends the processing and deactivates the display unit 23.

In the vehicle C, when a power switch (ACC) or a start switch (IGN) has been in an ON state in a state in which the pressure of engine oil is reduced, an oil pressure warning lamp 1a is lit and displayed on the meter device 1 as the warning image, as illustrated in FIG. 1. The oil pressure warning image 23b is an image of the same type as the oil pressure warning lamp 1a.

That is, the warning image displayed on the display unit 23 is equivalent to an image of the warning image displayed on the meter device 1.

Note that the warning image to be displayed on the meter device 1 and the display unit 23 may be an image other than the above, such as a high water temperature warning lamp (displayed when the temperature of cooling water is abnormally high), a malfunction warning lamp (displayed when an abnormality is found in an engine control system), a charge warning lamp (displayed when an abnormality is found in a charging system of a battery), a tire air pressure reduction warning lamp (displayed when air pressure of a tire is reduced), etc.

If it is determined by the control unit that the user is not seated (NO in step S6), the control unit determines whether the doors C5 of the vehicle C are locked (step S8). If it is determined by the control unit that the doors C5 are locked (YES in step S8), the control unit hides from display the oil pressure warning image 23b, which is the warning image on the display unit 23 (step S7). After that, the control unit ends the processing and deactivates the display unit 23.

If it is determined by the control unit that the doors C5 are not locked (NO in step S8), the control unit determines again whether or not an abnormality warning is generated on the vehicle C (step S9). For example, if is determined that no abnormality warning is generated on the vehicle C, such as that information indicating that the pressure of engine oil is reduced is not obtained from the ECU (NO in step S9), the oil pressure warning image 23b, which is the warning image on the display unit 23, is hidden from display (step S7). After that, the control unit ends the processing and deactivates the display unit 23.

If it is determined by the control unit that an abnormality warning on the vehicle C is given (YES in step S9), the control unit determines again whether the user is seated on the driver's seat C1 (step S6).

Note that, after the warning image has been deleted in step S a rendering presentation of first displaying an emblem (a logo) or a character of the manufacturer or the like of the vehicle C on the display unit 23 for a predetermined time, and then hiding from display the emblem or the character, etc., may be performed before the display unit 23 is deactivated.

By virtue of such display, the user is able to confirm the warning image by the display unit 23 outside the vehicle C after being authenticated. Consequently, when the abnormality is that related to a place not in the interior of the vehicle, the user can omit the action of getting into the vehicle C once and turning on the ACC switch. In other words, the display system can improve the convenience when the user outside the vehicle wishes to confirm the warning image.

### Second Embodiment

With reference to the flowchart illustrated in FIG. 4, the processing of a second embodiment when a display system controls an authentication device 2 will be described below. In the description, the same reference numerals are assigned to portions that are the same as those of the first embodiment described above and parts that are equivalent.

In a case where an abnormality has occurred in a vehicle C when a user is driving the vehicle C, the vehicle C displays a warning image (for example, an oil pressure warning lamp 1a, etc.) on a meter device 1 to warn the user of the abnormality.

A control unit determines whether or not an abnormality warning is generated on the vehicle C on the basis of information from an ECU (step S3 of FIG. 4). When the control unit obtains an abnormality warning from the ECU (YES in step S3 of FIG. 4), the control unit determines whether or not the user is seated on a driver's seat C1 (step S4 of FIG. 4). Since the user has stopped the vehicle C and got out of the driver's seat C1 in order to open the hood of an engine room and check an oil gauge of the engine, the control unit makes a determination that the user is not seated (NO in step S4), and displays, as illustrated in FIG. 5, an oil pressure warning image 23b indicating “Engine oil is decreased.” as the warning image on a display unit 23 (step S5).

Since the steps from step S6 onward are the same as those of the first embodiment, description of the subsequent steps will be omitted.

By virtue of such display, the user is able to confirm the warning image by the display unit 23 outside the vehicle C after getting out of the vehicle. Consequently, when an abnormality related to a place not in the interior of the vehicle is found, the user can omit unnecessary actions such as taking the trouble to look into the meter device 1 through a window of a door C5 after getting out of the vehicle, or getting back into the driver's seat C1. In other words, the display system can improve the convenience when the user outside the vehicle wishes to confirm the warning image.

### Third Embodiment

The processing of a third embodiment when a display system controls an authentication device 2 will be described below. In the description, the same reference numerals are assigned to portions that are the same as those of the first embodiment described above and parts that are equivalent.

At the time when a user opens a door C5 after turning off an IGN switch of a vehicle C, in a case where it is necessary to give an alighting time warning (i.e., a forgotten-to-return to P-position warning image, which is to be presented when a select lever is set to a position other than parking, for example), the vehicle C displays a warning image on a meter device 1 and also makes a warning sound by a buzzer or the like so that a user inside or outside the vehicle can hear the warning sound.

In addition to the forgotten-to-return to P-position warning image and the like, the alighting time warning includes, for example, a forgotten-to-switch power supply position to OFF warning (when the ACC switch is ON), a forgotten-to-turn off the light warning (when a light in the interior or exterior of the vehicle is on), a forgotten-to-close the window warning (when a window is open), a forgotten-to-close the door warning (when a door or a trunk is half-shut (i.e., not securely closed)), and the like.

A control unit determines whether or not an alighting time warning is generated on the vehicle C on the basis of information from an ECU (similar to step S3 of FIG. 4). When the control unit obtains an alighting time warning from the ECU (similar to YES in step S3 of FIG. 4), the control unit determines whether or not the user is seated on a driver's seat C1 (step S4 of FIG. 4).

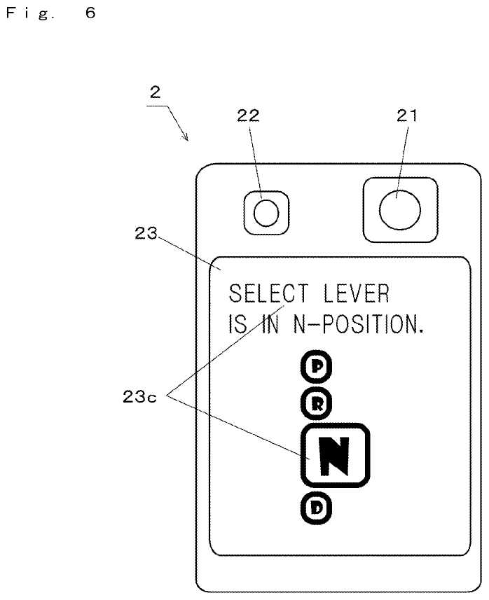

If it is determined by the control unit that the user is not seated (NO in step S4), the control unit displays, as illustrated in FIG. 6, a forgotten-to-return to P-position warning image 23c indicating “Select lever is in N-position.” as an alighting time warning image on a display unit 23 (similar to step S5).

Since the steps from step S6 onward are the same as those of the first embodiment, description of the subsequent steps will be omitted.

By virtue of such display, the user is able to confirm the alighting time warning by the display unit 23 outside the vehicle C after getting out of the vehicle. Consequently, when the user recognizes the alighting time warning by the warning sound, the user can omit unnecessary actions such as taking the trouble to look into the meter device 1, or getting back into the driver's seat C1. In other words, the display system can improve the convenience when the user outside the vehicle wishes to confirm the warning image.

### Fourth Embodiment

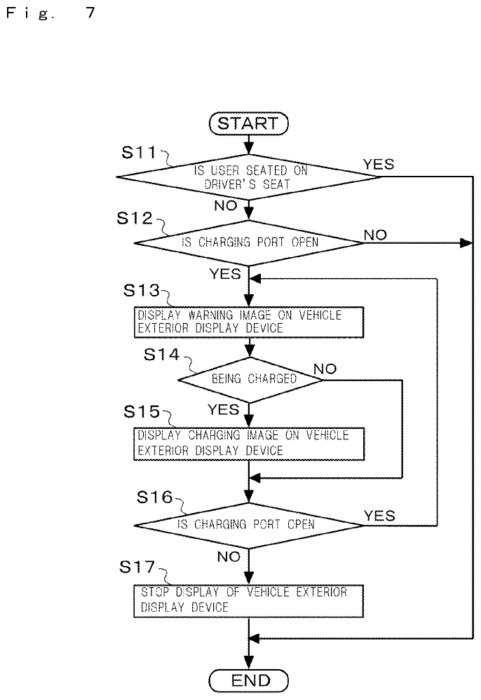

The processing of a fourth embodiment when a display system controls an authentication device 2, in accordance with a flowchart illustrated in FIG. 7, will be described below. It is assumed that a vehicle C of the present embodiment is an EV vehicle (an electric vehicle including an in-vehicle battery and an electric motor as a driving source).

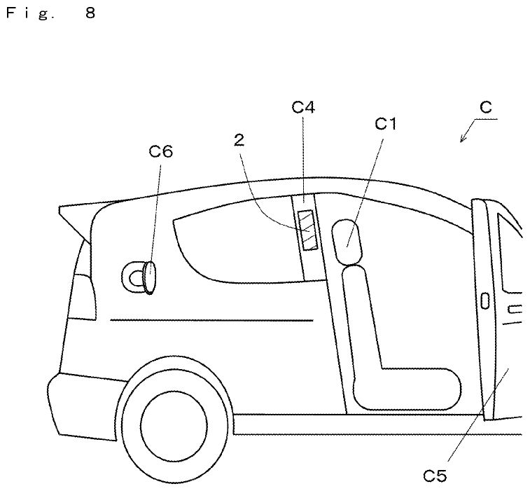

A control unit determines whether or not a user is seated on a driver's seat C1 (step S11). If it is determined by the control unit that the user is not seated (NO in step S11), the control unit determines whether or not a flap C6 of a charging port (i.e., a flap of an input port of an energy source) is open, as illustrated in FIG. 8 (step S12).

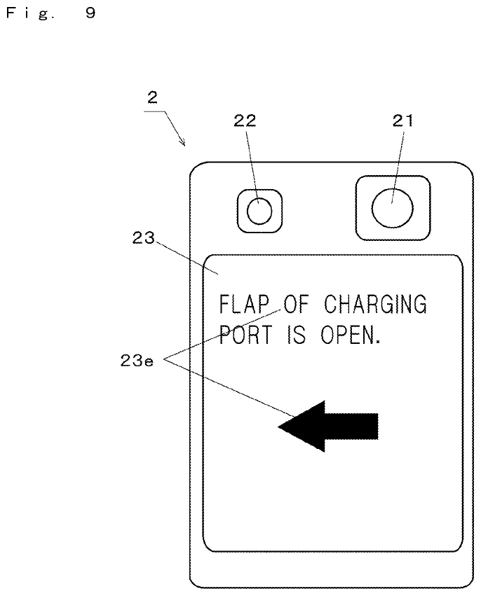

If it is determined by the control unit that the flap C6 of the charging port is open (YES in step S12), the control unit displays, as illustrated in FIG. 9, a charging flap opening warning image 23e indicating “Flap of charging port is open.” as a warning image on a display unit 23 (step S13).

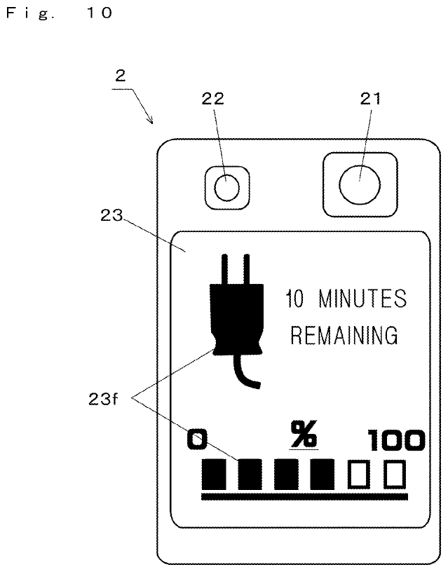

Next, the control unit determines whether or not the vehicle C is being charged (step S14). If the vehicle C is being charged (YES in step S14), the control unit displays, as illustrated in FIG. 10, a charging image (an energy source remaining capacity image) 23f indicating the amount of charge and the remaining charging time on the display unit 23 (step S15). If it is determined by the control unit that the vehicle C is not being charged (NO in step S14), the processing proceeds to step S16.

Next, the control unit determines again whether the flap C6 of the charging port is open (step S16). If it is determined by the control unit that the flap C6 of the charging port is not open (NO in step S16), the control unit hides (erases) the display of the display unit 23 (step S17). After that, the processing is e n d e d.

If it is determined by the control unit that the flap C6 of the charging port is open (YES in step S16), the control unit returns to step S13 and determines again whether the vehicle C is being charged (step S14).

By virtue of such display, the user is able to know that the flap C6 of the charging port is open and also confirm the state of charge by the display unit 23 outside the vehicle C. Consequently, the user can be prevented from forgetting to close the flap C6 of the charging port and can also ascertain the state of charge. In other words, the display system can improve the convenience for the user outside the vehicle. Note that the present disclosure is not limited to the present embodiments described above, and various modifications may be made within the scope of the gist of the present disclosure.

For example, it has been described that the warning image displayed on the display unit 23 is equivalent to the warning image displayed on the meter device 1. However, the warning image to be displayed on the display unit 23 may be equivalent to a warning image displayed on meters and gauges other than the meter device 1, such as a head-up display (HUD) device, a car navigation device, an interior projection device, and a display.

For example, although it has been described that the authentication device 2 is disposed on the B-pillar C4 of the vehicle C, the authentication device 2 may be disposed on the A-pillar or the C-pillar, or may be disposed on an exterior body (a cowl) on the periphery of the door C5 of the vehicle C or at an appropriate place of a window pane of the door C5 of the vehicle C. For example, although it has been described that the authentication device 2 includes the display unit 23, the display unit 23 may be disposed separately from the authentication device 2 as with the case of a transparent display, for example, which is to be disposed on the window pane of the door C5.

For example, although it has been described that the authentication device 2 includes two cameras, i.e., the human body detection camera 21 and the authentication camera 22, a single camera may serve to carry out image capturing for human body detection and image capturing for authentication. For example, it has been described that as the human body detection camera 21, a camera is used. However, a Light Detection And Ranging (LiDAR) sensor, which radiates laser beams and measures the time taken until the radiated laser hits an object and is reflected back from the object, a radar sensor, which emits pulsed radio waves and detects a radio wave that has hit an object, such as a person, and has been reflected back from the object, or the like, may be used to detect the existence of an object (presence or absence information), and to output (transmit) a detection signal.

For example, it has been described that the display system authenticates a person on the basis of the features of the face. However, the display system may refer to a pupil, a fingerprint, a body shape of a person or a gesture (motion) of the person for authentication.

### REFERENCE SIGNS LIST

C Vehicle
C1 Driver's seat
C2 Steering wheel
C3 Instrument panel
C4 B-pillar
C5 Door
C6 Flap of charging port (flap of input port of energy source)
1 Meter device (instrumental device)
1a Oil pressure warning lamp
2 Authentication device
21 Human body detection camera
22 Authentication camera
23 Display unit
23a Authentication OK image
23b Oil pressure warning image
23c Forgotten-to-return to P-position warning image
23e Charging flap opening warning image
23f Charging image (energy source remaining capacity image)

1. A display system which displays, when a person is not seated on a driver's seat of a vehicle, a warning image regarding the vehicle on a display unit which is disposed on an exterior part of the vehicle.

2. The display system according to claim 1, wherein the display unit displays an authentication state of the person and a locked/unlocked state of a door of the vehicle.

3. The display system according to claim 1, wherein the warning image is also displayed on a meter of the vehicle.

4. The display system according to claim 1, wherein the warning image represents an alighting time warning about the vehicle.

5. The display system according to claim 1, wherein the warning image is hidden from display when the person is seated on the driver's seat.

6. The display system according to claim 1, wherein the warning image is hidden from display when a door of the vehicle is locked.

7. The display system according to claim 1, wherein the warning image is displayed when a flap of an input port of an energy source of the vehicle is open.

8. The display system according to claim 7, wherein the display unit displays a remaining capacity image of the energy source.
